(19) United States
(12) Patent Application Publication
(10) Pub. No.: US 2012/0087215 A1
(43) Pub. Date: Apr. 12, 2012

(54) WRISTWATCH WITH DETACHABLE WATCHCASE

(76) Inventor: Mariarosa Fantoni, Gramolazzo (IT)

(21) Appl. No.: 13/377,924

(22) PCT Filed: Jun. 16, 2010
(86) PCT No.: PCT/IB2010/052710

§ 371 Date: Dec. 13, 2011

(30) Foreign Application Priority Data
Jun. 17, 2009 (IT) PI2009A000074

(51) Int. Cl. G04B 37/16

(52) U.S. Cl. 368/281

(57) ABSTRACT

A special housing comprising a holding structure and binding means allows a pocket watch to be transformed in an extremely simple and reliable way into a wristwatch. The pocket watch is seated inside the housing and kept in position by the binding means, which are conceived in such a way as to not affect negatively the watch final aesthetic appearance. In a way equally simple, the case can be disengaged in order to be used again as a pocket watch or as a neck pendant by adding a simple chain.

### FIELD OF THE INVENTION

The present invention relates to a wristwatch having a removable case, so as to be used as a pocket watch.

The invention relates also to a housing containing the case of a pocket watch, particularly useful to adapt a pocket watch for use as a wristwatch.

### Description of the Prior Art

A wristwatch is commonly formed by a case that contains the face and the whole underlying mechanical and/or electronic part, and has protrusions, called lugs, that allow to fix the watch strap to the case, usually by means of spring cylinders.

Otherwise, the pocket watch case has no lugs, but it is provided with a cover hinged on one side to protect the face and its glass, and with a ring in correspondence to the adjusting crown, through which a chain passes.

This last type of watch has suffered a considerable drop of popularity, caused by the advent of wristwatches, so much that the related market has been reduced substantially to the collecting one.

However, it is to be added that the market of pocket watches is finding a breath of fresh air by virtue of their use as real jewels, addressed specifically to women, using them as neck pendants.

From this point of view, recently, there have been developed new models of pocket watches, having special aesthetic quality, particularly suitable for the above mentioned use.

However, in order to make the most of this type of objects, that represent real jewels, there is the need to allow them to be used as pocket watches as well as pendant watches o wristwatches, a possibility not being allowed by the pocket watches or wristwatches of the prior art.

### SUMMARY OF THE INVENTION

The object of the present invention is to propose a watch that can be used without any distinction and with the same comfort as a pocket watch, as well as a wristwatch or suspended around the neck as a pendant with a chain.

Another object of the present invention is to propose a housing aimed at containing the case of a pocket watch adapting it for use as a wristwatch.

A further object of the present invention is to propose a housing, like the above specified one, capable of allowing secure fastening of a wristwatch case, wherein the technical solutions aimed at allowing such fastening do not jeopardize, but on the contrary enhance the watch aesthetic value.

The above mentioned objects are obtained by means of a housing comprising a holding structure of a watch case aimed at coupling with at least a portion of the side surface of said case, binding means for securing said case acting upon the side surface of the case, and connecting means for a watch strap. A pocket watch can become a wristwatch by means of a housing according to the invention in an extremely simple way.

Advantageously, the holding structure is provided with an internal aperture shaped like the shape of said case, as see in a top view, being as high as the thickness of the case, and said watch strap connecting means are two lugs integral to said holding structure and placed at opposite sides of the external side surface.

Still advantageously, the holding structure is provided with a radial through groove of a size matching the size of a protrusion of said case located in correspondence to an adjusting crown.

The binding means comprise at least one elastic member housed in a specific cavity made in the internal surface of said holding structure and aimed at interfering with the side surface of said case.

Advantageously, the binding means comprise at least one screw pin housed in a threaded hole made in said holding structure and at least a further member protruding from the internal surface of said holding structure placed at a substantially opposite side with respect to said screw pin.

Preferably, there are two screw pins which are situated at the sides of said radial through groove and operated by means of crowns, while said further protruding member is an elastic pin placed diametrically opposite to said radial through groove.

The above mentioned objects are obtained also by a wristwatch comprising a housing like the one outlined above and a pocket watch placed in said housing and kept joined therewith by said binding means.

Advantageously, the side surface of the case of said pocket watch is provided with cavities, with which said binding means engage, said cavities being preferably formed by a single annular groove.

Finally, still advantageously, the protrusion of said case in correspondence to the adjusting crown and the housing are shaped in such a way that when said pocket watch is placed in said housing, the upper surface of said protrusion is coplanar with the upper surface of said holding structure.

The conformation of the housing and binding means being provided are such as to ensure an extremely stable coupling of the case to its housing obtaining a wristwatch that shows aesthetic characteristics quite similar to a conventional type wristwatch.

At the same time, it is extremely easy to detach the case to use again the case as a pocket watch or to wear it around the neck by means of a simple chain.

### BRIEF DESCRIPTION OF DRAWINGS

These and other characteristics of the invention will become more easily comprehensible from the following description of the preferred embodiments of the invention, given as not limiting examples, with reference to the enclosed drawings, in which:

FIG. 1 is a perspective view of a housing according to the invention;

FIG. 2 is a different perspective view of the housing of FIG. 1;

FIG. 3 is a top view of the housing of FIG. 1 without binding means;

FIG. 4 is a side view of the housing of FIG. 3;

FIG. 5 is another side view of the housing of FIG. 3;

FIG. 6 is a perspective view of a pocket watch that can be introduced in the housing of FIG. 1;

FIG. 7 shows the watch of FIG. 6 while it is introduced into the housing of FIG. 1;

FIG. 8 is a perspective view of a watch according to the invention comprising the case of a pocket watch seated in a housing according to the invention;

FIG. 9 is a top view of the watch of FIG. 7;

FIG. 10 is a section view taken along the section plane X-X of FIG. 9;

FIG. 11 is a perspective view of a different embodiment of a housing according to the invention;

FIG. 12 is a top view of binding means that can be associated to the housing of FIG. 11;

FIG. 13 shows the case of a pocket watch that can be seated in the housing of FIG. 11;

FIGS. 14 to 17 are top views of different embodiments of the watch according to the invention.

### DESCRIPTION OF THE PREFERRED EMBODIMENTS

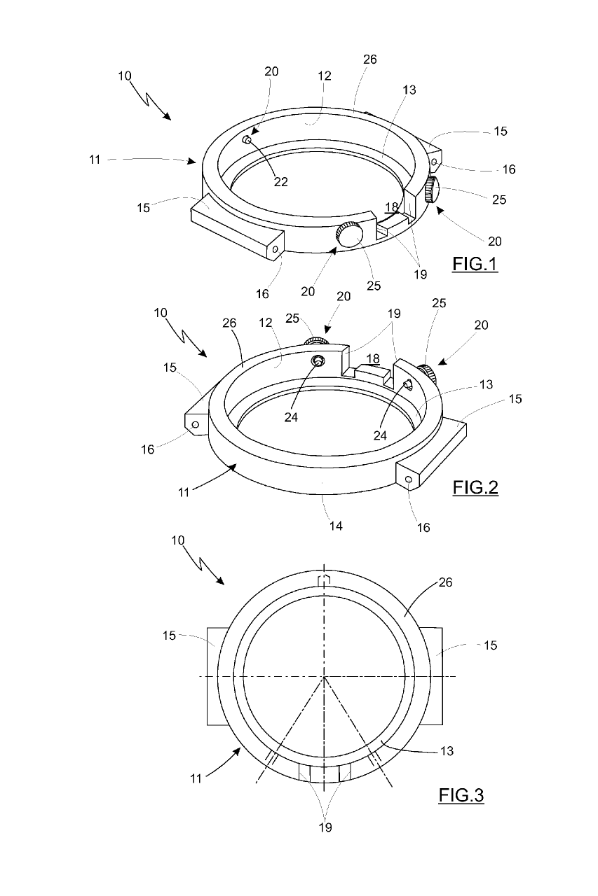

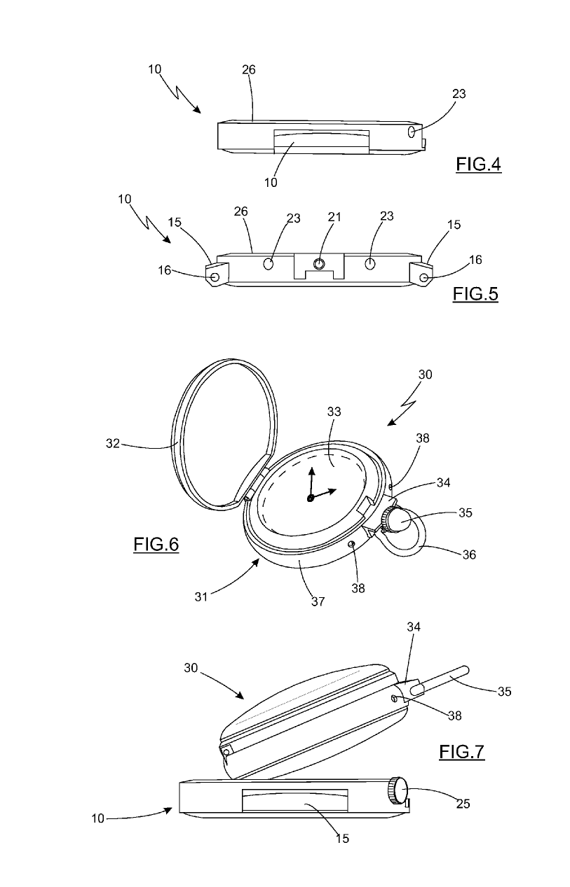

With reference to FIGS. 1 to 5, reference numeral 10 indicates a housing, as a whole, for seating a case of a pocket watch aimed at making a pocket watch adapt for use as a wristwatch. The housing includes a holding structure 11, having shape substantially of a collar with circular section, as high as the thickness of the case 31 of a pocket watch 30, shown in FIG. 6.

In the embodiment shown in FIGS. 1 to 10, the holding structure 11 has an internal aperture, defined by the internal surface 12, having a diameter slightly greater than the maximum diameter of the case 31, so as to allow its easy introduction, but with not too big clearance. An edge 13, protruding internally, is made at the lower end of the holding structure 11. Connecting means 15 of a watch strap are made in the external surface 14, in diametrically opposite positions, said connecting means including lugs provided with a hole 16 for introduction of a spring cylinder, not shown as such connecting means belong to a widely known technique. A radial through groove 18, whose lateral walls 19 are aimed at defining an angular reference for the introduction of the watch 30, is provided in the holding structure 11, at 90° from the connecting means 15.

Seats for binding means 20 of the watch 30 are made in the holding structure 11. Specifically, in a position diametrically opposite to the groove 18, there is located a seat 21 for an elastic pin 22, while two threaded through holes 23 are provided on the two sides of the groove 18, for screwing two screw pins 24, having crowns 25 at their ends, so as to facilitate screwing thereof. The crowns 25 have shape and size identical with the watches normal adjusting crowns, thus allowing to hide the binding means and contributing to the watch general aesthetic aspect. In this aspect, it is to be noted that also the upper surface 26 of the holding structure 11 can be made in such a way as to house a rotating ring, or other decorative elements usually provided in similar position in the conventional wristwatches.

The pocket watch 30 shown in FIG. 6 includes, according to the known technique, a case 31 that houses the face and all the internal mechanical and/or electronic members and a hinged cover 32, protecting the glass 33. At the three o'clock position, there is a protrusion 34, from which an adjusting crown 35 comes out, and to which a ring 36 is fastened for a chain that can pass therethrough, so that the watch can be worn around the neck or tied to a pocket. The width of the protrusion 34 corresponds to the width of the groove 18 of the housing 10, so that the watch 30 can be referred angularly to the housing 10. Cavities 38 are made in the side surface 37 of the case 31, in correspondence to the binding means 20.

FIG. 7 shows the watch 30, with the cover 32 closed, during the introduction into the housing 10. The watch is introduced initially from the side of the pin 22, which is resilient and thus it is pressed in its seat by the case 31, and then it is rotated until the protrusion 34 is completely introduced in the groove 18.

FIGS. 8, 9 and 10 show a wristwatch 40, constituted by the pocket watch 30 placed in the housing 10.

In the sectional view of FIG. 10, it is possible to observe how the lower edge 13 of the holding structure 11 acts as a further support of the case 31, forming an abutment surface for the bottom 39, preventing the case 31 from coming out of the housing 10 from the bottom, even if the binding means 20 are not operated. The pins 24 are screwed until they engage with the respective cavities 38, in this way preventing the pocket watch 30 from uncoupling by accident from the housing 10.

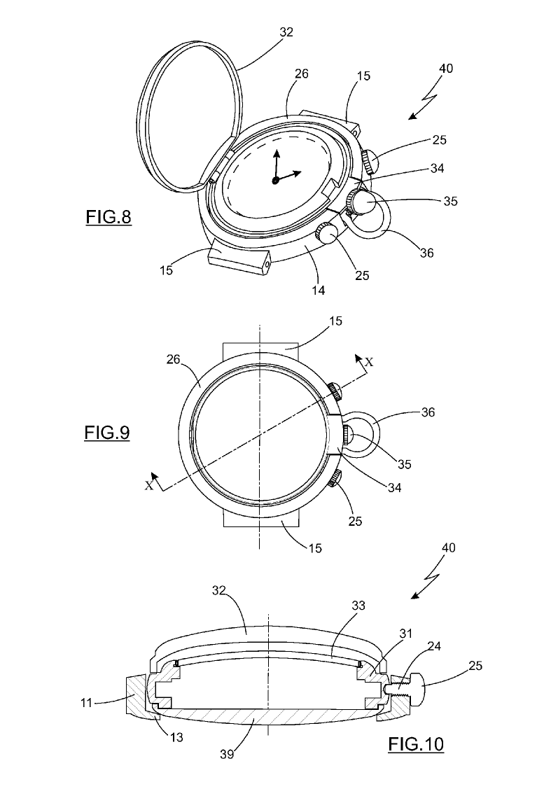

It is possible to see in the FIGS. 8 and 9 how the upper surface of the protrusion 34 is aligned with the upper surface 26 of the holding structure 11, thus obtaining a continuity, which allows decorative elements to be obtained 360° around the watch face.

As it appears from the previous description, the housing 10 allows a normal pocket watch 30 to become a wristwatch 40 in an extremely simple and reliable way.

The conformations of the holding structure 11 and binding means 20 are such that the wristwatch 40 shows all the aesthetic characteristics of a normal wristwatch, since the pocket watch 30 is perfectly integrated and it is not possible to notice, at least at first sight, that there are two independent bodies assembled together. The overall dimensions of the watch 40 are quite similar to those of a normal wristwatch and the pins 24 constitute an extremely secure fastening mode against unintentional uncoupling. The lower edge 13 allows a further support of the case 31, prevents the case 31 from coming out from the bottom and at the same time, leaves a wide lower opening to allow the pins 24, once disengaged, to exert pressure on the bottom 39 so as to uncouple it from the housing 10.

Certainly, the advantages related to the above described housing 10 and wristwatch 40 remain unchanged also in presence of modifications or with different embodiments that can be provided without departing from the inventive concept of the present invention.

In fact, as it is easy to guess, the above described configuration of the binding means is particularly effective and reliable from the technical point of view and, at the same time, it is particularly advantageous from the aesthetic point of view, however, other solutions can be adopted within the carrying out of the inventive concept of the invention.

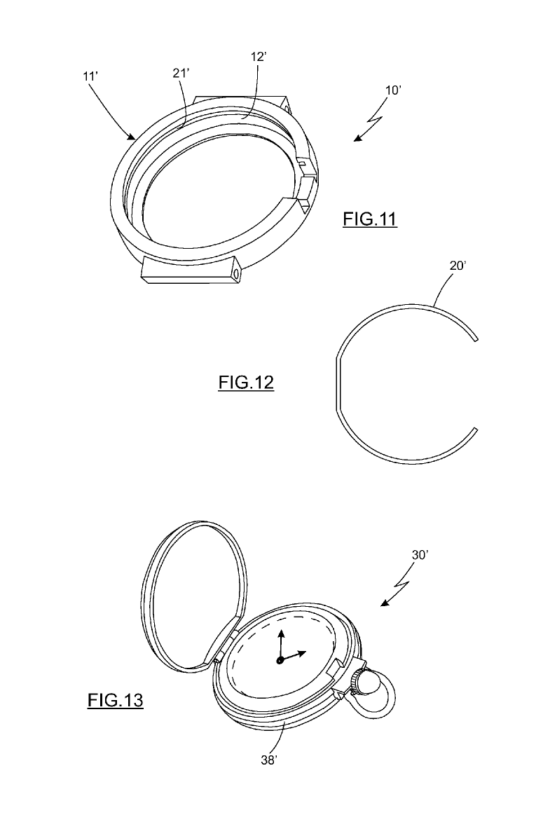

For example, in an embodiment of the housing 10′, shown in FIG. 11, the cavities 21 and 23 are substituted by an annular groove 21′, made in the internal surface 12′ of the holding structure 11′. Such a groove is aimed at housing an elastic member 20′, shown in FIG. 12, that forms the binding means of the pocket watch 30′, shown in FIG. 13, and is provided with a corresponding annular groove 38′. In this embodiment, the introduction and the removal of the watch 30′ from the housing 10′ are carried out entirely by pressure.

Still with reference to the binding means, the elastic pin 22 could be substituted by a rigid element, protruding from the internal surface of the housing and having a rounded and angularly elongated shape, or there could be even more elastic pins located in different angular positions. In the side surface 37 of the case 31 there could be a single annular groove 38′ instead of single cavities 38, aimed at housing various pins. Elastic means of different types, such as a leaf spring, made of harmonic steel, or many others, could be used as binding means.

Other versions can be surely provided as far as the binding means are concerned, in order to obtain a stable lock of the case 31 in a way as simple as possible and without influence on the watch overall aesthetic aspect.

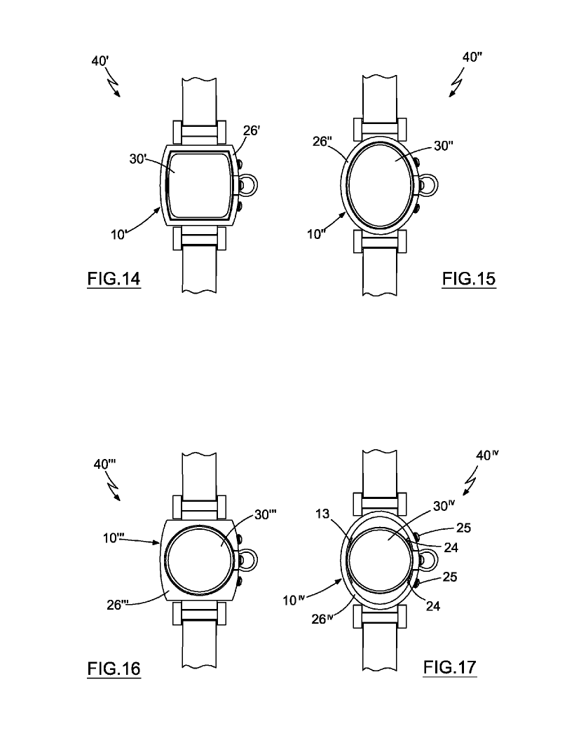

Finally, embodiments of the wristwatch of the invention are shown in FIGS. 14 to 17 to show how the configuration of the housing 10 can be even very different from the described one, to adapt to cases of different shapes or even only to give particular aesthetic characteristics to the watch.

In the watch 40′, represented in FIG. 14, the pocket watch 30′ is substantially rectangular, with two slightly rounded sides, and the housing 10′ is shaped accordingly, so as to have constant height of the upper surface 26′ and the internal aperture corresponding to the shape and dimensions of the case of the watch 30′. An analogous situation is shown in FIG. 15, in which however, both the pocket watch 30″ and the housing 10″ have an elliptical shape.

In the wristwatch 40′″, the housed pocket watch 30′″ has a circular shape and similarly, the internal aperture of the housing 10′″ has a circular shape, while externally the housing has a rectangular shape with two rounded sides. As apparent from the Figure, in this case, the height of the upper surface 26′″ of the housing is not constant.

The watch 40^{IV} of FIG. 17 proposes a further embodiment of the invention, in which the housed pocket watch 30^{IV} has a circular shape, while the housing 10^{IV} is elliptical externally and presents the elliptical internal aperture. In the last version, the side surface of the case mates with the internal aperture of the housing 10^{IV} only in proximity of the opposite ends, located at the three o'clock and nine o'clock positions, since the elastic pin 22 is present at the nine o'clock position, not seen in the Figure, whereas the screw pins 24 adjusted by means of the crowns 25 are present above and below the three o'clock position. The lower edge 13, instead of extending along the whole periphery of the internal aperture, is provided only in two sections, at the three o'clock and nine o'clock positions, since it supports the bottom only in proximity of these areas.

These and other versions or modifications could be applied to the housing and wristwatch according to the invention, still remaining within the protective scope defined by the following claims.

1. Housing (10) for a pocket watch case (31), comprising at least one holding structure (11) for restraining said case (31) apt to couple with at least a portion of the side surface (37) of said case (31), binding means (20) for securing said case (31) acting upon the side surface (37) of the case, and connecting means (15) for connecting a wrist strap or a band.

2. The housing (10) according to claim 1, wherein said holding structure (11) is provided with an internal aperture shaped like the shape of said case (31) in a top view, being as high as the thickness of the case (31), said wrist strap or band connecting means (15) being two lugs integral to said holding structure (11) and placed at opposite sides of the external side surface (14).

3. The housing (10) according to claim 1, wherein said holding structure (11) is provided with a radial through groove (18) of a size matching the size of a protrusion (34) of said case (31) located in correspondence to an adjusting crown (35).

4. The housing (10, 10′) according to claim 1, wherein said binding means (20, 20′) comprise at least one elastic member housed in a cavity (21, 21′) made in an internal surface (12, 12′) of said housing (10, 10′) and apt to press against the side surface (37) of said case (31).

5. The housing (10) according to claim 5, wherein said binding means (20) comprise at least one screw pin (24) housed in a threaded hole (23) made in said holding structure (11) and at least a further member protruding from the internal surface (12) of said holding structure (11) placed at a substantially opposite side with respect to said screw pin (24).

6. The housing (10) according to claim 5, wherein there are two screw pins (24) placed close to the ends of said radial through groove (18) and operated through crowns (25), said further member being an elastic pin (22) placed opposite to said radial through groove (18).

7. A wrist watch (40) comprising a housing according to claim 3 and a pocket watch (30) housed in said housing and restrained by said binding means (20).

8. The wrist watch (40) according to the claim 7, wherein the side surface of the case (31) of said pocket watch is provided with cavities (38) where said binding means (20) engage.

9. The wrist watch (40) according to claim 8, wherein said cavities are a single annular groove (38′)

10. The wrist watch (40) according to claim 7, wherein said protrusion (34) of said case (31) and said housing (10) are shaped so that when said pocket watch (30) is housed in said housing (10), the upper surface of said protrusion (34) lays on the same plane with the upper surface (26) of said holding structure (11).
